(19) United States
(12) Patent Application Publication
(10) Pub. No.: US 2025/0239595 A1
(43) Pub. Date: Jul. 24, 2025

(54) COATED ACTIVE MATERIAL, ELECTRODE MIXTURE, BATTERY, AND COAT SOLUTION

(71) Applicant: TOYOTA JIDOSHA KABUSHIKI KAISHA, Toyota-shi (JP)

(72) Inventor: Masaru KUBOTA, Okazaki-shi (JP)

(73) Assignee: TOYOTA JIDOSHA KABUSHIKI KAISHA, Toyota-shi (JP)

(21) Appl. No.: 19/032,797

(22) Filed: Jan. 21, 2025

(30) Foreign Application Priority Data
Jan. 23, 2024 (JP) 2024-007881

(51) Int. Cl. H01M 4/36; H01M 4/02; H01M 4/505; H01M 4/525; H01M 10/0562

(52) U.S. Cl. CPC H01M 4/366; H01M 4/505; H01M 4/525; H01M 10/0562; H01M 2004/028; H01M 2300/0068

(57) ABSTRACT

A coated active material includes: an electrode active material; and a coating layer that covers the electrode active material, wherein: the electrode active material includes a Li element, an M element, and an O element; M is a metal other than Li, and at least includes Ni; a molar ratio (Ni/M) of Ni to M is 80% or more; the coating layer includes a B element, a P element, a La element, and an O element; and a molar ratio (La/P) of the La element to the P element is 0.005 or more and 0.15 or less.

### CROSS-REFERENCE TO RELATED APPLICATION

This application claims priority to Japanese Patent Application No. 2024-007881 filed on Jan. 23, 2024, incorporated herein by reference in its entirety.

### BACKGROUND

### 1. Technical Field

The present disclosure relates to a coated active material, an electrode mixture, a battery, and a coat solution.

### 2. Description of Related Art

In recent years, batteries are under active development. For example, in automotive industries, development of batteries to be used in a battery electric vehicle (BEV), a plug-in hybrid electric vehicle (PHEV), or a hybrid electric vehicle (HEV) is promoted. Further, a technology of covering a surface of an electrode active material to be used in the battery with a phosphorus-based coat solution is known.

For example, Japanese Unexamined Patent Application Publication No. 2023-136753 discloses a composite particle including a positive electrode active material particle, and a coating film that covers at least a part of a surface of the positive electrode active material particle and includes a phosphorus compound. Further, JP 2023-136753 A discloses producing a composite particle by mixing a positive electrode active material particle and a water-based coating solution (water-based coat solution) containing phosphorus and drying the mixture.

### SUMMARY

An electrode active material having a high nickel ratio is promising from the viewpoint of an increase in capacity. Meanwhile, when the water-based coat solution containing phosphorus comes into contact with the electrode active material having a high nickel ratio, an exchange reaction seems to occur between H⁺ and Li⁺ to generate high-resistance NiO. As a result, a resistance increase occurs. This is a specific problem in a case in which an electrode active material having a high nickel ratio and a water-based coat solution containing phosphorus (coating layer containing phosphorus) are combined with each other.

The present disclosure provides a coated active material that can reduce a resistance increase even when an electrode active material having a high nickel ratio and a coating layer containing phosphorus are combined with each other.

A coated active material according to a first aspect of the present disclosure includes: an electrode active material; and a coating layer that covers the electrode active material, wherein: the electrode active material includes a Li element, an M element, and an O element; M is a metal other than Li and at least includes Ni; a molar ratio (Ni/M) of Ni to M is 80% or more; the coating layer includes a B element, a P element, a La element, and an O element; and a molar ratio (La/P) of the La element to the P element is 0.005 or more and 0.15 or less.

In the coated active material according to the above-mentioned aspect, La/P may be 0.01 or more and 0.11 or less.

In the coated active material according to the above-mentioned aspect, a molar ratio (B/P) of the B element to the P element may be 0.5 or more and 2.0 or less.

In the coated active material according to the above-mentioned aspect, a coverage of the coating layer with respect to the electrode active material may be 75% or more.

In the coated active material according to the above-mentioned aspect, M may further include at least one type among Co, Mn, and Al.

An electrode mixture according to a second aspect of the present disclosure includes: the coated active material according to the above-mentioned aspect; and at least one of an electrically conductive material and a binder.

In the electrode mixture according to the above-mentioned aspect, the electrode mixture may include a solid electrolyte.

In the electrode mixture according to the above-mentioned aspect, the solid electrolyte may be a sulfide solid electrolyte.

A battery according to a third aspect of the present disclosure includes: a positive electrode layer; a negative electrode layer; and an electrolyte layer disposed between the positive electrode layer and the negative electrode layer, wherein the positive electrode layer or the negative electrode layer includes the electrode mixture of the above-mentioned aspect.

In the battery according to the above-mentioned aspect, the positive electrode layer may include the electrode mixture.

In the battery according to the above-mentioned aspect, the electrolyte layer may include a solid electrolyte.

A coat solution of forming the coating layer in the coated active material of the above-mentioned aspect, according to a fourth aspect of the present disclosure, includes: a solute including a B element, a P element, and a La element; and water that is a solvent, wherein: a molar ratio (La/P) of the La element to the P element is 0.001 or more and 0.100 or less; and an absorbance of the coat solution is 0.1 or less.

The coated active material in the present disclosure provides an effect that the resistance increase can be reduced even when the electrode active material having a high nickel ratio and the coating layer containing phosphorus are combined with each other.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic sectional view exemplifying a coated active material in the present disclosure;

FIG. 2 is a schematic sectional view exemplifying a battery in the present disclosure; and

FIG. 3 is a graph showing resistances of the batteries produced in Examples 1 to 5 and Comparative Example 1.

### DETAILED DESCRIPTION OF EMBODIMENTS

Hereinafter, a coated active material, an electrode mixture, a battery, and a coat solution in the present disclosure are described in detail.

### A. Coated Active Material

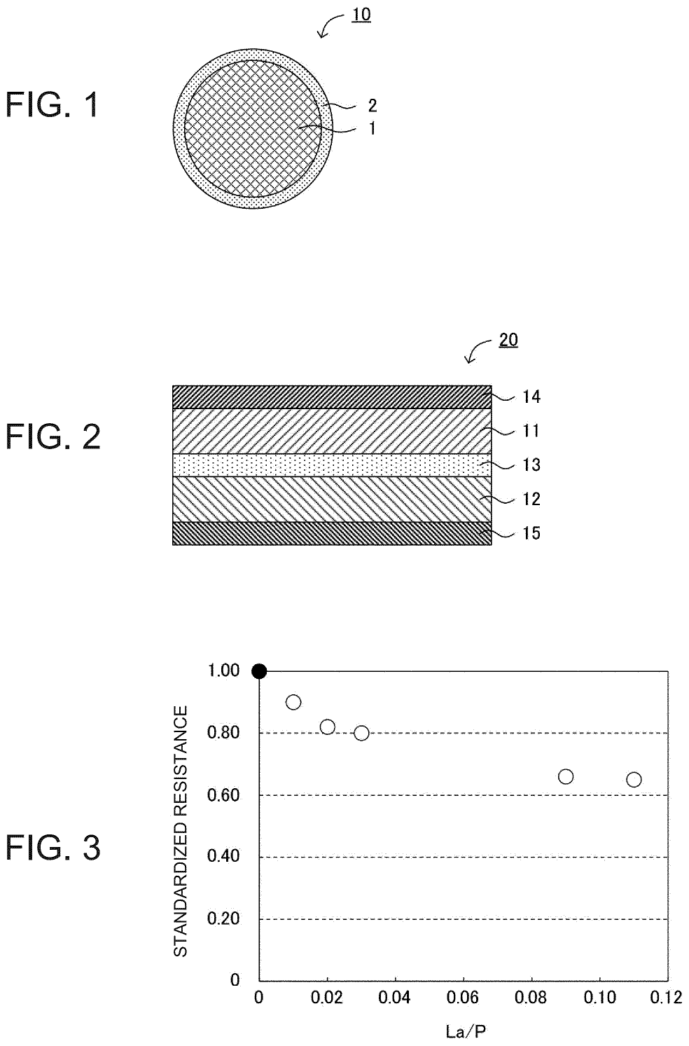

FIG. 1 is a schematic sectional view exemplifying the coated active material in the present disclosure. A coated active material 10 illustrated in FIG. 1 includes an electrode active material 1 and a coating layer 2 that covers the electrode active material 1. The electrode active material 1 includes a Li element, an M element (M is a metal other than Li and at least includes Ni), and an O element. Further, a molar ratio (Ni/M) of Ni to M is 80% or more. Meanwhile, the coating layer 2 includes a B element, a P element, a La element, and an O element, and a molar ratio (La/P) of the La element to the P element is 0.005 or more and 0.15 or less.

According to the present disclosure, when the La element is added to the coating layer, even when an electrode active material having a high nickel ratio and a coating layer containing phosphorus are combined with each other, a coated active material that can reduce a resistance increase is obtained. As described above, JP 2023-136753 A discloses producing a composite particle by mixing a positive electrode active material particle and a water-based coat solution containing phosphorus and drying the mixture. Meanwhile, an electrode active material having a high nickel ratio is promising from the viewpoint of an increase in capacity. When the water-based coat solution containing phosphorus comes into contact with the electrode active material having a high nickel ratio, an exchange reaction seems to occur between H⁺ and Li⁺ to generate high-resistance NiO. As a result, a resistance increase occurs. For example, when the electrode active material is LiNiO₂, the following reaction seems to occur.

LiNiO₂+H⁺→NiOOH+Li⁺

NiOOH→NiO+0.5H₂O+0.25O₂

In particular, when the water-based coat solution containing phosphorus is used, it seems that the presence of the P element causes moisture to stay in the coating layer, and thus the above-mentioned exchange reaction is promoted. In contrast, in the present disclosure, with the La element having high affinity with the P element being added, the moisture seems to be prevented from staying in the coating layer, with the result that the above-mentioned exchange reaction is reduced. Accordingly, the resistance increase can be reduced. Further, the coating layer includes the P element, and hence the chemical stability of the coating layer is improved. Moreover, the coating layer includes the B element in addition to the P element, and hence the ionic conduction of the coating layer can be improved while the chemical stability of the coating layer is improved.

### 1. Coating Layer

The coating layer in the present disclosure is a layer that covers the electrode active material. Further, the coating layer includes the B element, the P element, and the O element. The coating layer may further include a Li element. Further, the coating layer preferably has a PO₄ structure.

In the coating layer, a molar ratio (La/P) of the La element to the P element is normally 0.005 or more and 0.15 or less, and may be 0.01 or more and 0.11 or less. When La/P is excessively small, the effect of reducing the resistance by the La element may not be able to be sufficiently obtained. Meanwhile, when La/P is excessively large, the production may become difficult.

In the coating layer, a molar ratio (B/P) of the B element to the P element is not particularly limited, but is, for example, 0.5 or more and 2.0 or less, and may be 0.8 or more and 1.25 or less or 0.9 or more and 1.11 or less. Further, when the coating layer further includes a Li element, a molar ratio (Li/(P+B)) of the Li element to the sum of the P element and the B element is not particularly limited, but is, for example, 0.3 or more and 1.2 or less, and may be 0.5 or more and 1.0 or less.

The coverage of the coating layer with respect to the electrode active material is not particularly limited, but is, for example, 75% or more, and may be 80% or more. When the coverage is excessively low, the resistance increase caused by the high resistance layer generated by the reaction between the electrode active material and the electrolyte may not be able to be sufficiently reduced. Meanwhile, the coverage may be 100% or less than 100%. The coverage in the present disclosure is obtained by calculating an elemental ratio from intensity ratios of respective main elements based on X-ray photoelectron spectroscopy (XPS) measurement, and is obtained as a percentage of the elements included in the coating layer with respect to a sum of the elements included in the electrode active material and the elements included in the coating layer.

The thickness of the coating layer is not particularly limited, but is, for example, 1 nm or more and 100 nm or less, and may be 5 nm or more and 50 nm or less or 10 nm or more and 30 nm or less. The thickness of the coating layer is obtained as, for example, an average value of thicknesses of a plurality of samples (for example, 100 or more samples) observed by a scanning electron microscope (SEM) or a transmission electron microscope (TEM).

### 2. Electrode Active Material

The electrode active material in the present disclosure normally includes a Li element, an M element, and an O element. M is a metal other than Li (including a metalloid), and at least includes Ni. M other than Ni may be a transition metal, or may be a metal (including a metalloid) belonging to group 13 to group 16 in the periodic table. Further, M other than Ni may be one type of metal or two or more types of metals. Of those, M other than Ni is preferably at least one type among Co, Mn, Al, V, and Fe.

A molar ratio (Ni/M) of Ni to M is normally 80% or more, and may be 85% or more or 90% or more. Meanwhile, Ni/M may be 100% or less than 100%.

The electrode active material may include, in addition to the Li element, the M element, and the O element, a nonmetal element such as a P element. Further, the crystal structure of the electrode active material is not particularly limited. Examples thereof include a layered rock-salt structure, a spinel structure, and an olivine structure.

As one example of the composition of the electrode active material, LiNiₓCo_{y}Al₂O₂ (0.80≤x, 0≤y, 0≤z, x+y+z=1) can be given. Symbol x is normally 0.80 or more, and may be 0.85 or more or 0.90 or more. Symbol y may be 0 or larger than 0. Further, symbol y is, for example, 0.20 or less. Symbol z may be 0 or larger than 0. Further, symbol z is, for example, 0.10 or less.

As another example of the composition of the electrode active material, LiNiₐCo_{b}Mn_{c}O₂ (0.80≤a, 0≤b, 0≤c, a+b+c=1) can be given. Symbol a is normally 0.80 or more, and may be 0.85 or more or 0.90 or more. Symbol b may be 0 or larger than 0. Further, symbol b is, for example, 0.20 or less. Symbol c may be 0 or larger than 0. Further, symbol c is, for example, 0.20 or less.

The shape of the electrode active material is normally a particulate shape. A particle size D₅₀ of the electrode active material is, for example, 100 nm or more, and may be 1 μm or more or 5 μm or more. Meanwhile, the particle size D₅₀ of the electrode active material is, for example, 50 μm or less, and may be 20 μm or less. In the present disclosure, the particle size D₅₀ corresponds to a particle size corresponding to cumulative 50% by volume measured by a laser diffraction particle size distribution measuring device.

### 3. Coated Active Material

The coated active material in the present disclosure is normally used in a battery. The electrode active material in the coated active material may be a positive electrode active material or a negative electrode active material, but the former is preferable. Further, the method of producing the coated active material is not particularly limited, but examples of the method include a method including a preparation step of preparing the electrode active material and the coat solution, and a coating layer formation step of covering the electrode active material with the coat solution and drying the electrode active material to form the coating layer.

In the preparation step, the electrode active material and the coat solution are prepared. The electrode active material is similar to the content described in “A. Coated Active Material” above. Meanwhile, the coat solution is described in “D. Coat Solution” later. Further, in the coating layer formation step, the electrode active material is covered with the coat solution and dried to form the coating layer. Examples of the method of covering the electrode active material with the coat solution and drying the electrode active material include a spray drying method. It is to be noted that the present disclosure can also provide a method of producing a coated active material including the above-mentioned preparation step and coating layer formation step.

### B. Electrode Mixture

An electrode mixture in the present disclosure includes the above-mentioned coated active material, and at least one of an electrically conductive material and a binder.

According to the present disclosure, with use of the above-mentioned coated active material, even when an electrode active material having a high nickel ratio and a coating layer containing phosphorus are combined with each other, an electrode mixture that can reduce a resistance increase is obtained.

The electrode mixture includes the coated active material, and at least one of the electrically conductive material and the binder. The coated active material is similar to the content described in “A. Coated Active Material” above. The electrode active material in the coated active material may be a positive electrode active material or a negative electrode active material, but the former is preferable. That is, the electrode mixture may be a positive electrode mixture or a negative electrode mixture, but the former is preferable.

A percentage of the coated active material in the electrode mixture is, for example, 20% by weight or more, and may be 30% by weight or more or 40% by weight or more. When the percentage of the coated active material is excessively small, a sufficient energy density may not be able to be obtained. Meanwhile, the percentage of the coated active material is, for example, 80% by weight or less, and may be 70% by weight or less or 60% by weight or less. When the percentage of the coated active material is excessively large, the ionic conduction and the electronic conduction in the electrode mixture may be relatively reduced.

The electrode mixture includes at least one of the electrically conductive material and the binder. Examples of the electrically conductive material include a carbon material, metal particles, and a conductive polymer. Examples of the carbon material include particulate carbon materials such as acetylene black (AB) and Ketjen black (KB) and fibrous carbon materials such as carbon fiber, carbon nanotube (CNT), and carbon nanofiber (CNF). Further, examples of the binder include a rubber-based binder and a fluorine-based binder.

The electrode mixture may further include a solid electrolyte. The solid electrolyte may be an organic solid electrolyte such as a gel electrolyte, or may be an inorganic solid electrolyte such as a sulfide solid electrolyte or an oxide solid electrolyte. Of those, the solid electrolyte is preferably a sulfide solid electrolyte. The reason therefor is because the ionic conduction is high.

The sulfide solid electrolyte normally at least contains a Li element and a S element. The sulfide solid electrolyte further preferably contains a Me element (Me is at least one type among P, As, Sb, Si, Ge, Sn, B, Al, Ga, and In). Further, the sulfide solid electrolyte may contain a halogen element such as F, Cl, Br, or I.

The sulfide solid electrolyte may be a glass-based (amorphous) sulfide solid electrolyte, a glass-ceramic-based sulfide solid electrolyte, or a crystalline sulfide solid electrolyte. The sulfide solid electrolyte may have a crystal phase. Examples of the above-mentioned crystal phase include a Thio-LISICON type crystal phase, an argyrodite type crystal phase, and an LGPS type crystal phase.

The composition of the sulfide solid electrolyte is not particularly limited, but examples thereof include xLi₂S·(1−x)P₂S₅ (0.5≤x<1) and yLiI·zLiBr(100−y−z)(xLi₂S·(1−x)P₂S₅) (0.5≤x<1, 0≤y≤30, 0≤z≤30). In those compositions, symbol x preferably satisfies 0.7≤x<0.8. Further, as another example of the composition of the sulfide solid electrolyte, Li_{7-x-2y}PS_{6-x-y}X_{y} can be given. Symbol X indicates at least one type among F, Cl, Br, and I, and symbols x and y satisfy 0≤x and 0≤y. Further, as another example of the composition of the sulfide solid electrolyte, Li₄₋ₓMe₁₋ₓPₓS₄ (0<x<1) can be given. Me is at least one type among Al, Zn, In, Ge, Si, Sn, Sb, Ga, and Bi.

### C. Battery

FIG. 2 is a schematic sectional view exemplifying a battery in the present disclosure. A battery 20 illustrated in FIG. 2 includes a positive electrode layer 11, a negative electrode layer 12, an electrolyte layer 13 disposed between the positive electrode layer 11 and the negative electrode layer 12, a positive electrode current collector 14 that collects a current of the positive electrode layer 11, and a negative electrode current collector 15 that collects a current of the negative electrode layer 12. In the present disclosure, the positive electrode layer 11 or the negative electrode layer 12 includes the electrode mixture described in “B. Electrode Mixture” above.

According to the present disclosure, with use of the above-mentioned electrode mixture, even when an electrode active material having a high nickel ratio and a coating layer containing phosphorus are combined with each other, a battery that is reduced in a resistance increase is obtained. As described above, the electrode mixture may be a positive electrode mixture or a negative electrode mixture, but the former is preferable. Hereinafter, details of a battery in a case in which the electrode mixture is a positive electrode mixture are described.

### 1. Positive Electrode Layer

The positive electrode layer in the present disclosure includes the above-mentioned electrode mixture (positive electrode mixture). The electrode mixture is similar to the content described in “B. Electrode Mixture” above, and hence description thereof is omitted here. Further, the positive electrode layer may include an electrolyte as required. The electrolyte is similar to the content described in “3. Electrolyte Layer”. The thickness of the positive electrode layer is, for example, 0.1 μm or more and 1,000 μm or less, and may be 0.1 μm or more and 500 μm or less or 0.1 μm or more and 100 μm or less. Further, examples of the method of forming the positive electrode layer include a method of applying the electrode mixture (positive electrode mixture) to the positive electrode current collector.

### 2. Negative Electrode Layer

The negative electrode layer is a layer including at least a negative electrode active material. Further, the negative electrode layer may include at least one of an electrolyte, an electrically conductive material, and a binder as required.

Examples of the negative electrode active material include metal active materials such as Li, a Si-based active material, a carbon active material such as graphite, and an oxide active material such as Li₄Ti₅O₁₂.

The negative electrode active material is preferably a Si-based active material. The reason therefor is because the battery can be increased in capacity. The Si-based active material is an active material including Si as a main component. The Si-based active material may be Si alone, a Si alloy, or a Si oxide. Further, the Si-based active material may include a diamond type crystal phase, a type-I clathrate crystal phase, or a type-II clathrate crystal phase. In the crystal phase of the type-I clathrate or the type-II clathrate, a plurality of Si elements forms a polyhedron (cage) including pentagons or hexagons. This polyhedron has a space therein that can enclose Li ions, and hence the volume change in the charging and discharging can be reduced.

As the shape of the negative electrode active material, for example, a particulate shape can be given. The particle size D₅₀ of the negative electrode active material is not particularly limited, but is, for example, 10 nm or more, and may be 100 nm or more. Meanwhile, the particle size D₅₀ of the negative electrode active material is, for example, 50 μm or less, and may be 20 μm or less.

The electrolyte used in the negative electrode layer is similar to the content described in “3. Electrolyte Layer”. Further, the electrically conductive material and the binder used in the negative electrode layer are similar to the content described in “B. Electrode Mixture” above, and hence description thereof is omitted here. The thickness of the negative electrode layer is, for example, 0.1 μm or more and 1,000 μm or less, and may be 0.1 μm or more and 500 μm or less or 0.1 μm or more and 100 μm or less.

### 3. Electrolyte Layer

The electrolyte layer is a layer formed between the positive electrode layer and the negative electrode layer, and at least includes an electrolyte. The electrolyte may be a solid electrolyte or a liquid electrolyte (electrolyte solution).

The solid electrolyte is similar to the content described in “B. Electrode Mixture” above, and hence description thereof is omitted here. Meanwhile, the electrolyte solution preferably includes a supporting salt and a solvent. Examples of the supporting salt (lithium salt) of the electrolyte solution having a lithium ionic conduction include inorganic lithium salts such as LiPF₆, LiBF₄, LiClO₄, and LiAsF₆ and organic lithium salts such as LiCF₃SO₃, LiN(CF₃SO₂)₂, LiN(C₂F₅SO₂)₂, LiN(FSO₂)₂, and LiC(CF₃SO₂)₃. Examples of the solvent used in the electrolyte solution include cyclic esters (cyclic carbonates) such as ethylene carbonate (EC), propylene carbonate (PC), and butylene carbonate (BC) and linear esters (linear carbonates) such as dimethyl carbonate (DMC), diethyl carbonate (DEC), and ethyl methyl carbonate (EMC). The electrolyte solution preferably includes two or more types of solvents.

The thickness of the electrolyte layer is, for example, 0.1 μm or more and 1,000 μm or less, and may be 0.1 μm or more and 500 μm or less or 0.1 μm or more and 100 μm or less.

### 4. Other Configurations

The battery in the present disclosure preferably includes the positive electrode current collector that collects a current of the positive electrode layer, and the negative electrode current collector that collects a current of the negative electrode layer. Examples of the material of the positive electrode current collector include SUS, aluminum, nickel, iron, titanium, and carbon. Meanwhile, examples of the material of the negative electrode current collector include SUS, copper, nickel, and carbon.

The battery in the present disclosure may further include a restraining jig that applies a restraining pressure to the positive electrode layer, the electrolyte layer, and the negative electrode layer along a thickness direction thereof. In particular, when the electrolyte layer is a solid electrolyte layer, in order to form good ionic conduction path and electronic conduction path, a restraining pressure is preferably applied. The restraining pressure is, for example, 0.1 MPa or more, and may be 1 MPa or more or 5 MPa or more. Meanwhile, the restraining pressure is, for example, 100 MPa or less, and may be 50 MPa or less or 20 MPa or less.

### 5. Battery

The type of the battery in the present disclosure is not particularly limited, but is typically a lithium-ion battery. Further, the battery in the present disclosure may be a liquid battery including an electrolyte solution as the electrolyte layer, or may be a solid-state battery including a solid electrolyte layer as the electrolyte layer. The solid-state battery may be a semi-solid-state battery or an all-solid-state battery. Further, the battery in the present disclosure may be a primary battery or a secondary battery, but, of those, the secondary battery is preferable. The reason therefor is because the battery can be repeatedly charged and discharged, and can be effectively used as, for example, an on-vehicle battery.

Examples of the application of the battery include a power supply for a vehicle such as a hybrid electric vehicle (HEV), a plug-in hybrid electric vehicle (PHEV), a battery electric vehicle (BEV), a gasoline vehicle, or a diesel vehicle. In particular, the battery is preferably used for a power supply for drive of the hybrid electric vehicle (HEV), the plug-in hybrid electric vehicle (PHEV), or the battery electric vehicle (BEV). Further, the battery may be used as a power supply for a mobile object other than a vehicle (for example, a train, a ship, or an airplane), or may be used as a power supply for an electric product such as an information processing device.

### D. Coat Solution

The coat solution in the present disclosure is a coat solution for forming the coating layer in the coated active material described in “A. Coated Active Material” above. The coat solution includes a solute including a B element, a P element, and a La element, and water that is a solvent. A molar ratio (La/P) of the La element to the P element is 0.001 or more and 0.100 or less. Further, the absorbance of the coat solution is 0.1 or less.

According to the present disclosure, with the La element being added such that a predetermined absorbance can be obtained, even when an electrode active material having a high nickel ratio is combined, a coat solution that can reduce a resistance increase is obtained.

The coat solution includes the solute including the B element, the P element, and the La element, and water that is the solvent. The solute may further include an O element. Of those, the solute preferably has a PO₄ structure. Further, the coat solution may further include a Li element.

In the coat solution, a molar ratio (La/P) of the La element to the P element is normally 0.001 or more and 0.100 or less, and may be 0.003 or more and 0.080 or less. When La/P is excessively small, the effect of reducing the resistance by the La element may not be able to be sufficiently obtained. Meanwhile, when La/P is excessively large, the production may become difficult.

In the coat solution, a molar ratio (B/P) of the B element to the P element is not particularly limited, but is, for example, 0.5 or more and 2.0 or less, and may be 0.8 or more and 1.25 or less or 0.9 or more and 1.11 or less. Further, when the coat solution further includes a Li element, a molar ratio (Li/(P+B)) of the Li element to the sum of the P element and the B element is not particularly limited, but is, for example, 0.3 or more and 1.2 or less, and may be 0.5 or more and 1.0 or less.

The absorbance of the coat solution is normally 0.1 or less, and may be 0.05 or less or 0.001 or less. The method of measuring the absorbance is as described in Examples described later.

The method of producing the coat solution is not particularly limited, but examples of the method include a method of dissolving a solute including a B source, a P source, and a La source in water that is the solvent. The B source is not particularly limited as long as the B source is a simple substance or a compound including the B element, and examples thereof include a boric acid (H₃BO₃). The P source is not particularly limited as long as the P source is a simple substance or a compound including the P element, and examples thereof include an orthophosphoric acid (H₃PO₄) and a metaphosphoric acid (HPO₃). Further, the coat solution preferably includes an O source. Examples of the O source include an O element included in the above-mentioned B source or P source. Further, the above-mentioned solute may include a Li source. The Li source is not particularly limited as long as the Li source is a simple substance or a compound including the Li element, and examples thereof include lithium hydroxide monohydrate (LiOH·H₂O).

It is to be noted that the present disclosure is not limited to the above-mentioned embodiment. The above-mentioned embodiment is exemplary, and anything that has substantially the same configuration and produces similar actions and effects as a technical idea that is described in the claims of the present disclosure is included in the technical scope of the present disclosure.

### Comparative Example 1

### Production of Coat Solution

A metaphosphoric acid (produced by FUJIFILM Wako Pure Chemical Corporation) and deionized water were mixed at “Metaphosphoric acid:Ion-exchanged water”=4.52:191.8 (ratio by weight) to obtain an aqueous solution. A boric acid (produced by NACALAI TESQUE, INC.) was added and dissolved to the obtained aqueous solution such that the molar ratio (B/P) of the B element to the P element became 1.0. Thus, the coat solution was obtained.

### Production of Coated Active Material

Active material particles (LiNi_{0.81}Co_{0.15}Al_{0.04}O₂, particle size D₅₀=4.5 μm) were dispersed in the obtained coat solution to prepare a slurry. The solid concentration of the slurry was 69% by weight. Next, the slurry was dried with use of a spray drying device manufactured by BUCHI Corporation “product name: Mini Spray Dryer B-290” to form the coating layer on the surface of the active material particle. The drying air temperature of the spray drying device was 200° C., and the drying air flow rate was 0.45 m³/min. Next, the active material particle having the coating layer formed thereon was subjected to heat treatment under air atmosphere to obtain the coated active material. The heat treatment temperature was 200° C., and the heat treatment time was 5 hours.

### Example 1

A metaphosphoric acid (produced by FUJIFILM Wako Pure Chemical Corporation) and deionized water were mixed at “Metaphosphoric acid:Ion-exchanged water”=4.52:191.8 (ratio by weight) to obtain an aqueous solution. A boric acid (produced by NACALAI TESQUE, INC.) was added and dissolved to the obtained aqueous solution such that the molar ratio (B/P) of the B element to the P element became 1.0. Moreover, a lanthanum oxide (produced by FUJIFILM Wako Pure Chemical Corporation) was added and dissolved such that the molar ratio (La/P) of the La element to the P element became 0.003. Thus, the coat solution was obtained. The coated active material was obtained similarly to Comparative Example 1 except that the obtained coat solution was used.

### Examples 2 to 5

The coat solution was obtained similarly to Example 1 except that the molar ratio (La/P) of the La element to the P element was changed to each of 0.006, 0.01, 0.05, and 0.075. The coated active material was obtained similarly to Comparative Example 1 except that the obtained coat solution was used.

### Comparative Example 2

The coat solution was obtained similarly to Example 1 except that the molar ratio (La/P) of the La element to the P element was changed to 0.100. The coated active material was obtained similarly to Comparative Example 1 except that the obtained coat solution was used.

### EVALUATION

### Absorbance Measurement

The absorbance of the coat solution obtained in each of Examples 1 to 5 and Comparative Examples 1 and 2 was measured. Specifically, 3.5 mL of the coat solution was added to a quartz cell (10 mm×10 mm×45 mm), and the absorbance was measured with use of an ultraviolet visible spectrophotometer (product name UV-1280, manufactured by SHIMADZU CORPORATION). When the absorbance at the wavelength of 660 nm was measured, in Examples 1 to 5 and Comparative Example 1, it was confirmed that the concentration of insoluble particulate matters present in the coat solution was extremely low (for example, see JIS-K0101). Meanwhile, in Comparative Example 2, the coat solution was visually opaque, and hence the absorbance measurement was not performed. Table 1 shows the results.

### Measurement of Coverage and La/P

The coverage of the coated active material obtained in each of Examples 1 to 5 and Comparative Examples 1 and 2 was measured by X-ray photoelectron spectroscopy (XPS). Specifically, an X-ray photoelectron spectroscopy device (manufactured by ULVAC-PHI, Inc., PHIX-tool) was used to perform surface elemental analysis of the coated active material. Narrow scan analysis was performed with pass energy of 224 eV. After that, analysis software (MultiPak, manufactured by ULVAC-PHI) was used to calculate an elemental ratio from the detected intensity values of C1s, O1s, P2p, Ni2p3, Co2p3, Al2p, B1s, and La3d3, and the value of (La+P+B)/(La+P+B+Ni+Co+Al) [%] was obtained as the coverage. Further, the molar ratio (La/P) of the La element to the P element was also obtained from the elemental ratio. Table 1 shows the results.

### Resistance Measurement

The coated active material obtained in each of Examples 1 to 5 and Comparative Examples 1 and 2 was used as the positive electrode active material to produce a battery, and a resistance thereof was measured.

First, a positive electrode active material (coated active material), a sulfide solid electrolyte (10LiI-15LiBr-75Li₃PS₄), an electrically conductive material (VGCF), a binder (SBR), and a dispersion medium (heptane) were mixed to prepare a positive electrode slurry. A mixing ratio of the positive electrode active material and the sulfide solid electrolyte was “Positive electrode active material:Sulfide solid electrolyte”=6:4 (ratio by volume). 3 parts by mass of the electrically conductive material and 3 parts by mass of the binder were added per 100 parts by weight of the positive electrode active material. The positive electrode slurry was sufficiently agitated by an ultrasonic homogenizer, and the positive electrode slurry was applied to the surface of the positive electrode current collector (Al foil) to form a coating film. The coating film was dried on a hot plate at 100° C. for 30 minutes. Thus, a positive electrode web was obtained. A disk-shaped positive electrode was cut out from the positive electrode web. The positive electrode had an area of 1 cm².

Next, the negative electrode and the solid electrolyte layer were prepared. The negative electrode active material was graphite. The positive electrode, the solid electrolyte layer, and the negative electrode used the same type of sulfide solid electrolyte therebetween. In a cylindrical jig, the positive electrode, the solid electrolyte layer, and the negative electrode were stacked in the stated order to form a stack. The stack was pressed to form a power generation element. The power generation element was connected to terminals to obtain a battery (all-solid-state battery). An open circuit voltage (OCV) of the obtained all-solid-state battery was adjusted to 2.03 V, and then constant current discharge was performed. Further, the voltage drop in 5 seconds was divided by the current amount to measure the battery resistance. The discharge current rate was 2.5 C. The resistance of the battery of Comparative Example 1 was used as a reference (1.00) to relatively evaluate the resistance of the battery of each Example and each Comparative Example. Table 1 and FIG. 3 show the results.

TABLE 1

| | | | | | Coated active | | |
|---|---|---|---|---|---|---|---|
| | Coat solution | | | | material | | |
| | Containing | | | | Coverage | | Standardized |
| | elements | P/B | La/P | Absorbance | [%] | La/P | resistance |
| Comparative | P, B, O | 1.0 | 0.000 | <0.001 | 91 | 0 | 1.00 |
| Example 1 | | | | | | | |
| Example 1 | P, B, La, O | 1.0 | 0.003 | <0.001 | 90 | 0.01 | 0.90 |
| Example 2 | P, B, La, O | 1.0 | 0.006 | <0.001 | 92 | 0.02 | 0.82 |
| Example 3 | P, B, La, O | 1.0 | 0.010 | <0.001 | 92 | 0.03 | 0.80 |
| Example 4 | P, B, La, O | 1.0 | 0.050 | <0.001 | 92 | 0.09 | 0.66 |
| Example 5 | P, B, La, O | 1.0 | 0.075 | <0.001 | 92 | 0.11 | 0.65 |
| Comparative | P, B, La, O | 1.0 | 0.100 | Opaque | — | 0.02 | Not |
| Example 2 | | | | | | | measured |

As shown in Table 1, in Examples 1 to 5 and Comparative Example 1, the value of La/P in the coating layer became larger than the value of La/P in the coat solution. The reason therefor seems to be because La was segregated. Further, as shown in Table 1 and FIG. 3, it was confirmed that Examples 1 to 5 had a resistance lower than Comparative Example 1. As described above, it was confirmed that, with La being added to the coating layer, even when an electrode active material having a high nickel ratio and a coating layer containing phosphorus were combined with each other, the resistance increase was able to be reduced. Meanwhile, in Comparative Example 2, the coat solution was opaque, and it was confirmed that the coat solution was not a solution but a dispersion liquid. Accordingly, a compositional variation occurred, and a desired coated active material was not able to be obtained.

What is claimed is:

1. A coated active material, comprising:
an electrode active material; and
a coating layer that covers the electrode active material, wherein:
the electrode active material includes a Li element, an M element, and an O element;
M is a metal other than Li, and at least includes Ni;
a molar ratio (Ni/M) of Ni to M is 80% or more;
the coating layer includes a B element, a P element, a La element, and an O element; and
a molar ratio (La/P) of the La element to the P element is 0.005 or more and 0.15 or less.

2. The coated active material according to claim 1, wherein La/P is 0.01 or more and 0.11 or less.

3. The coated active material according to claim 1, wherein a molar ratio (B/P) of the B element to the P element is 0.5 or more and 2.0 or less.

4. The coated active material according to claim 1, wherein a coverage of the coating layer with respect to the electrode active material is 75% or more.

5. The coated active material according to claim 1, wherein M further includes at least one type among Co, Mn, and Al.

6. An electrode mixture, comprising:
the coated active material according to claim 1; and
at least one of an electrically conductive material and a binder.

7. The electrode mixture according to claim 6, wherein the electrode mixture includes a solid electrolyte.

8. The electrode mixture according to claim 7, wherein the solid electrolyte is a sulfide solid electrolyte.

9. A battery, comprising:
a positive electrode layer;
a negative electrode layer; and
an electrolyte layer disposed between the positive electrode layer and the negative electrode layer,
wherein the positive electrode layer or the negative electrode layer includes the electrode mixture of claim 6.

10. The battery according to claim 9, wherein the positive electrode layer includes the electrode mixture.

11. The battery according to claim 9, wherein the electrolyte layer includes a solid electrolyte.

12. A coat solution of forming the coating layer in the coated active material of claim 1, the coat solution comprising:
a solute including a B element, a P element, and a La element; and
water that is a solvent, wherein:
a molar ratio (La/P) of the La element to the P element is 0.001 or more and 0.100 or less; and
an absorbance of the coat solution is 0.1 or less.
